(19) United States
(12) Patent Application Publication
(10) Pub. No.: US 2009/0039949 A1
(43) Pub. Date: Feb. 12, 2009

(54) METHOD AND APPARATUS FOR PRODUCING A LOW-NOISE, TEMPERATURE-COMPENSATED BANDGAP VOLTAGE REFERENCE

(76) Inventor: GIOVANNI PIETROBON, Berkeley, CA (US)

Correspondence Address: O'Melveny & Myers LLP;IP&T Calendar Department LA-1118, 400 South Hope Street, Los Angeles, CA, 90071-2899, US

(21) Appl. No.: 12/186,290

(22) Filed: Aug. 5, 2008

Related U.S. Application Data
(60) Provisional application No. 60/955,022, filed on Aug. 9, 2007.

(51) Int. Cl. G05F 1/10

(52) U.S. Cl. 327/539

(57) ABSTRACT

A bandgap voltage reference circuit is achieved that does not resort to the use of resistors or regulation loops and is thus able to achieve improved noise performance while also exhibiting absolute stability, no start-up issues, and low input-voltage operation. Subcircuits comprised of four interconnected transistors of different junction areas are used to create differential base-emitter voltage sources with magnitudes that vary in direct proportion to absolute temperature. The voltages from several of these subcircuits are combined without resistors to create a voltage source that is proportional to absolute temperature. An additional transistor is operated as a forward-biased PN junction to create a voltage source that varies in a sense that is complementary to absolute temperature. By a judicious choice of the transistor-junction-area ratios and the number of subcircuits that are summed, the combination of the complementary and proportional voltage references produces a bandgap voltage reference that is nearly constant with variations in temperature. The unique summation technique presented results in a bandgap reference with a noise performance that is more than an order of magnitude better than the prior art, particularly for applications requiring low current consumption.

### RELATED APPLICATION DATA

This application claims the benefit, pursuant to 35 U.S.C. § 119(e), of U.S. provisional application Ser. No. 60/955,022, filed Aug. 9, 2007.

### BACKGROUND OF THE INVENTION

1. Field of the Invention

The present invention relates to analog integrated circuits, and particularly to temperature-compensated bandgap voltage reference circuits.

2. Description of Related Art

Bandgap voltage references are widely used in a variety of integrated circuits to provide a stable DC voltage reference that does not vary significantly with temperature. In its most common form, two PN junctions (diodes) are operated at different current densities, resulting in a voltage difference that is proportional to absolute temperature (“PTAT”), typically with a temperature coefficient near 0.2 mV per degree Kelvin. A resistor is used to convert this voltage to a current that is then passed through a third PN junction, creating a voltage that varies in a direction complementary to absolute temperature (“CTAT”), typically with a temperature coefficient near −2 mV per degree Kelvin. When the PTAT voltage is scaled up by approximately a factor of ten and then added to the CTAT voltage, the first-order temperature dependence of the two components cancel one another, resulting in a reference voltage of approximately 1.25 V that does not vary significantly with temperature. It should be noted that 1.25V also corresponds to a transistor base-emitter voltage at zero degrees Kelvin.

Such a circuit was first introduced by Robert Widlar in 1971. R. Widlar, New Developments in IC Voltage Regulators, IEEE Journal of Solid State Circuit, February 1971, at 2-7. Other circuits based on this principle were introduced by others. See, e.g., A. P. Brokaw, A Simple Three Terminal IC Bandgap Reference, IEEE Journal of Solid State Circuit, December 1974, at 388-393. What all prior bandgap reference circuits have in common is the use of resistors to perform a conversion from voltage to current, multiplication by a ratio of resistor values, and then conversion back to voltage. This operation introduces a number of problems that disadvantage the circuit's operation.

First, the use of resistors introduces significant thermal noise, which is further exacerbated when the PTAT component is scaled up by a factor of ten in order to compensate the negative temperature coefficient of the CTAT component. Since resistive thermal noise is proportional to resistance, low-noise applications demand low resistance. However, low resistance results in large currents and thus high power dissipation, which is undesirable in most applications. Second, the active gain stages of the regulation loop inherent in the prior art introduce the possibility of instability, requiring that careful attention be paid to layout, managing parasitic capacitances that might send the circuit into oscillations. These stray capacitances, furthermore, are often difficult to model, requiring significant empirical effort to achieve good circuit performance. Third, bandgap reference circuits dependent on cascaded diode junctions can require relatively large supply voltages that are often incompatible with low-power applications. Finally, start-up circuitry is required to assure correct operation of the bandgap reference when power is applied, especially because other circuits will often rely on the stable output of the bandgap reference for their own proper startup. The design of such start-up circuitry is not trivial, and its operation can often be defeated by leakage currents, frustrating attempts to design simple drop-in modules suited to a variety of applications. These difficulties, among others, in the design of bandgap reference circuits are surveyed in Robert Pease, The Design of Bandgap Reference Circuits: Trials and Tribulations, IEEE 1990 Bipolar Circuit and Technology Meeting.

Accordingly, what is needed is a simple bandgap reference that does not depend on resistors or on an active regulation loop. Ideally, such a bandgap reference would have an order of magnitude better noise performance and would not suffer from potential instability or start-up problems.

### SUMMARY OF THE INVENTION

An embodiment of a bandgap reference in accordance with the present invention includes M complementary subcircuits, wherein M is an integer greater than zero. Each of the M complementary subcircuits is adapted to produce an output with a CTAT character such that an output voltage of each of the M complementary subcircuits tends to decrease in a substantially linear fashion as temperature increases.

The bandgap reference also includes N proportional subcircuits, where N is an integer greater than zero. Each of the N proportional subcircuits is adapted to produce a low-impedance output with a PTAT character such that an output voltage of each of the N proportional subcircuits tends to increase in a substantially linear fashion as temperature increases. The N proportional subcircuits are combined in series with the M complementary subcircuits, taking advantage of the low output impedance of all of the subcircuits, to create a bandgap reference output voltage.

In one embodiment, the N proportional subcircuits are adapted such that the sum of the output voltages of each of the N proportional subcircuits has a temperature slope with a magnitude that is substantially equal to the magnitude of the temperature slope of the sum of the M CTAT voltages. Under this condition, the sum of the N PTAT voltages and the M CTAT voltages, i.e. the bandgap reference output voltage, has a temperature slope that is substantially zero and thus substantially constant with temperature. For an embodiment using silicon transistors, this condition results in the sum of the N PTAT voltages being approximately equal to the sum of the M CTAT voltages near room temperature. For other semiconductor materials, such as germanium, the two voltage sums will be approximately equal at a different temperature that depends on the semiconductor material used.

In another embodiment of a bandgap reference in accordance with the invention, the sum of the N PTAT voltages is adapted to have a temperature slope with a magnitude that is larger or smaller than the temperature slope of the sum of the M CTAT voltages. This results in a bandgap reference output voltage that has a net positive or negative slope with temperature that can be set according to the requirements of the circuit application.

In one embodiment of a bandgap reference in accordance with the present invention, the M CTAT subcircuits each comprise a first NPN transistor and a second NPN transistor. The collector of the first NPN transistor connects to the base of the second NPN transistor; the emitter of the second NPN transistor connects to the base of the first NPN transistor; and the low-impedance CTAT output is taken from the emitter of the second NPN transistor.

In another embodiment in accordance with the present invention, the M CTAT subcircuits each comprise a PN diode junction that may comprise a diode, or a transistor in which the collector and base are connected such that it acts as a diode, or any other semiconductor circuit configured to present a PN junction developing a CTAT voltage.

In an embodiment of a bandgap reference in accordance with the present invention, the N proportional subcircuits each include four NPN transistors. The collector of the first NPN transistor connects to the base of the first NPN transistor and to the base of the second NPN transistor; the emitter of the first NPN transistor connects to the collector of the third NPN transistor and to the base of the fourth NPN transistor; and the emitter of the second NPN transistor connects to the base of the third NPN transistor and to the collector of the fourth NPN transistor. The low-impedance PTAT output is taken from the emitter of the fourth NPN transistor, measured with respect to the emitter of the third transistor. The magnitude of the PTAT voltage developed by each of the N proportional subcircuits is controlled by adjusting the relative size of the junction areas of the first, second, third, and fourth NPN transistors.

It should be appreciated that each of the transistors may be made up of a plurality of smaller transistors connected in parallel in accordance with methods well known in the art. Adjustment of the junction area of the transistors may accomplished by providing physical PN junctions that are larger or smaller than other transistors. Alternatively, a larger junction area may be achieved by combining a larger number of smaller transistors in parallel. In one embodiment, switches are used to selectively switch in and out parallel transistor elements in order to adjust the effective junction area of a transistor.

In a particular embodiment of the present invention, the junction area of the fourth NPN transistor is larger than the junction area of the third NPN transistor, and the junction area of the first NPN transistor is larger than the junction area of the second NPN transistor. The PTAT voltage output of each of the N PTAT subcircuits is adjusted to be substantially equal to one Nth of the sum of the M CTAT voltage outputs of the M CTAT subcircuits by properly selecting a first junction-area ratio of the first NPN transistor to that of the second NPN transistor and a second junction-area ratio of the fourth NPN transistor to that of the third NPN transistor. The PTAT voltage output is given by a natural logarithm of a product of the first junction-area ratio and the second junction-area ratio, scaled by a product of Boltzmann's constant and an absolute temperature divided by the charge of an electron.

In one possible embodiment of a bandgap reference in accordance with the present invention, the number of PTAT subcircuits, N, is set at four, and the number of CTAT subcircuits, M, is set at one. The first and second junction-area ratios are set according to the formula presented above to provide a PTAT voltage output from each of the four PTAT subcircuits that is substantially equal to one fourth of the CTAT output voltage.

In a particular embodiment of a bandgap reference in accordance with the present invention that includes four PTAT subcircuits and one CTAT subcircuit, the first junction-area ratio is set to approximately twenty, and the second junction-area ratio is set to approximately thirty-one.

The invention is not limited to implementation using NPN transistors. Embodiments of a bandgap reference in accordance with the present invention may be implemented using PNP transistors, as would be evident to one skilled in the art. In particular, one embodiment of a bandgap reference includes M CTAT subcircuits, each of which includes two PNP transistors. The collector of the first PNP transistor connects to the base of the second PNP transistor; the emitter of the second PNP transistor connects to the base of the first PNP transistor; and a low-impedance CTAT output is taken from the emitter of the second PNP transistor. In another embodiment, the M CTAT subcircuits comprise simple PN junctions (diodes) configured to develop a CTAT voltage.

In one embodiment, the N proportional subcircuits each include four PNP transistors. The collector of the third PNP transistor connects to its own base, and to the base of the fourth PNP transistor; the collector of the first PNP transistor connects to the emitter of the third PNP transistor and to the base of the second PNP transistor; and the collector of the second PNP transistor connects to the base of the first PNP transistor and to the emitter of the fourth PNP transistor. The low-impedance PTAT output is taken from the emitter of the second PNP transistor. The magnitude of the PTAT voltage developed by each of the N proportional subcircuits is controlled by adjusting the relative size of the junction areas of the first, second, third, and fourth PNP transistors.

In a particular embodiment of the present invention, the junction area of the third PNP transistor is larger than the junction area of the fourth PNP transistor, and the junction area of the second PNP transistor is larger than the junction area of the first PNP transistor. The PTAT voltage output of each of the N PTAT subcircuits is adjusted to be substantially equal to one Nth of the sum of the M CTAT voltage outputs of the M CTAT subcircuits by properly selecting a first junction-area ratio of the first PNP transistor to that of the second PNP transistor and a second junction-area ratio of the fourth PNP transistor to that of the third PNP transistor. The PTAT voltage output is given by a natural logarithm of a product of the first junction-area ratio and the second junction-area ratio, scaled by a product of Boltzmann's constant and an absolute temperature divided by the charge of an electron.

In one possible embodiment of a bandgap reference in accordance with the present invention, the number of PTAT subcircuits, N, is set at four, and the number of CTAT subcircuits, M, is set at one. The first and second junction-area ratios are set according to the formula presented above to provide a PTAT voltage output from each of the four PTAT subcircuits that is substantially equal to one fourth of the CTAT output voltage.

In a particular embodiment of a bandgap reference in accordance with the present invention that includes four PTAT subcircuits and one CTAT subcircuit, the first junction-area ratio is set to approximately twenty, and the second junction-area ratio is set to approximately thirty-one. In another exemplary embodiment, five PTAT subcircuits and one CTAT circuit are used together with a junction-area ratio of approximately sixteen.

In another embodiment of a bandgap reference in accordance with the present invention, the number of CTAT circuits, M, is set to two and the number of PTAT circuits, N, is set to eight. The series sum of all of the CTAT and PTAT circuits thus creates an output voltage reference of approximately 2.5 V.

Numerous other circuit topologies and variations of a bandgap reference that does not make use of resistors or amplifiers are possible and would lie within the scope and spirit of the present invention. Further advantages and embodiments of the invention will become clear to those skilled in the art by the study of the following detailed description and attached sheets of drawing that will first be described briefly.

### BRIEF DESCRIPTION OF THE DRAWINGS

FIG. 1 is a simplified schematic diagram of a bandgap voltage reference circuit in accordance with one exemplary embodiment of the invention;

FIG. 2 is block diagram of an alternative embodiment of the present invention;

FIG. 3 is a block diagram of yet another alternative embodiment of the present invention.

FIG. 4 is a block diagram of an additional embodiment of the present invention in which two stages are combined to create a reference voltage of a larger magnitude;

FIG. 5 is a plot of the RMS noise of an exemplary voltage reference in accordance with the present invention;

FIG. 6 is a plot of the noise voltage amplitude of an exemplary voltage reference in accordance with the present invention;

FIG. 7 is a plot of the output reference voltage as a function of temperature of an embodiment of the invention as simulated using a circuit simulation tool; and

FIG. 8 is a simplified block diagram of an alternative embodiment of a bandgap reference circuit in accordance with the present invention that uses PNP transistors.

### DETAILED DESCRIPTION OF THE PREFERRED EMBODIMENT

The present invention satisfies the need for an easily manufactured, low-noise bandgap voltage reference that does not suffer from start-up or instability problems and that can be operated from a low supply voltage. Unlike the prior art, this invention produces a bandgap voltage reference without resorting to the use of resistors or regulation loops and is thus able to achieve far better noise performance while exhibiting absolute stability and no start-up issues. The elimination of resistors is made possible by a novel summation technique presented in this invention which utilizes subcircuits developing PTAT voltages that have very low output impedances. This low output impedance enables these subcircuits to be cascaded and summed very accurately to reach a magnitude that precisely cancels the CTAT character of a voltage developed across a diode junction, resulting in a bandgap reference that is essentially constant with temperature. Alternatively, the temperature dependence can be adjusted to a desired slope suitable for a particular application by proper adjustment of the PTAT and CTAT circuits as described further below.

Several possible embodiments of the invention are disclosed herein, although the invention is not limited to these particular embodiments. Other advantages and applications of this invention will be apparent to those skilled in the art from the description and drawings presented below.

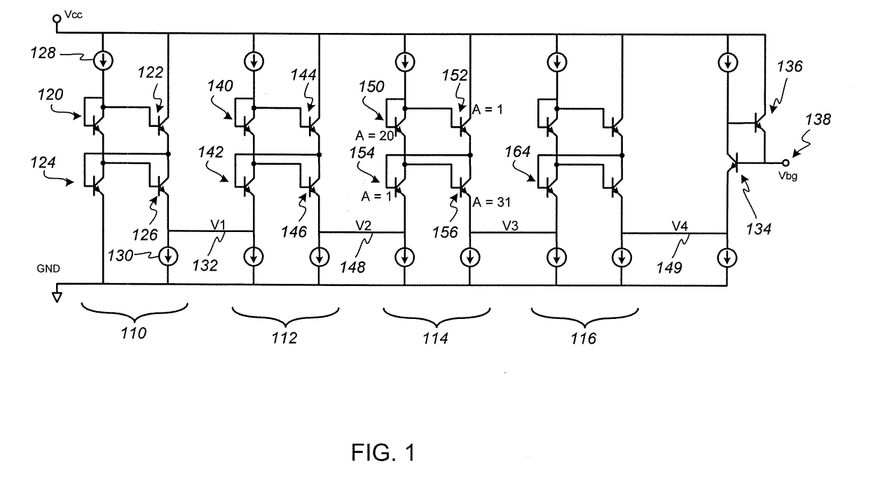

FIG. 1 is a simplified circuit diagram that illustrates one exemplary embodiment of the invention in silicon, though many other embodiments are possible. The circuit shown includes four subcircuits, 110, 112, 114, and 116, each of which includes four NPN transistors, e.g., 120, 122, 124, and 126, that act as voltage summing stages, generating the PTAT voltage component. An additional transistor 134 is configured to generate the CTAT voltage. Current sources 128 and 130 in subcircuit 110 are identically matched, although high-precision matching is not required, and they can be implemented using a current mirror. Subcircuits 112, 114, and 116 also include matched current sources as shown in FIG. 1. An additional transistor 136 is coupled with the CTAT transistor 134 to produce a low-impedance bandgap-reference output 138 at the base of CTAT transistor 134. It should be noted that the CTAT subcircuit can also be implemented as a single diode PN junction that may comprise a diode, a transistor in which the collector is connected to the base, or any other semiconductor circuit including a PN junction.

Subcircuit 110, including four transistors 120, 122, 124, and 126 is cross coupled as follows: the base of transistor 120 is tied to its own collector as well as to the base of transistor 122; the emitter of transistor 120 is tied to the collector of transistor 134 as well as to the base of transistor 126; the emitter of transistor 122 is tied to the collector of transistor 126 as well as to the base of transistor 124; and the emitter of transistor 124 is at ground potential. This arrangement results in matched currents flowing through each of the four transistors and produces a very low impedance output at the emitter of transistor 126. If all four transistors were identical, the voltage at the emitter of transistor 126 would match that of transistor 124. However, in this embodiment, the junction area of transistor 120 is chosen to be larger than that of transistor 122, and similarly, that of transistor 126 is chosen to be larger than that of transistor 124. For example, in the embodiment shown in FIG. 1, the junction-area ratio of the two lower transistors in each subcircuit is thirty-one, and the junction-area ratio of the two upper transistors is twenty, as indicated in FIG. 1 adjacent to transistors 150, 152, 154, and 156 in subcircuit 114. This results in a lower current density through the larger transistors and a correspondingly smaller base-emitter voltage drop than in the smaller transistors. The difference in the base-emitter voltage drop of each transistor pair is given by kT/q multiplied by the natural logarithm of the junction area ratio, where k is Boltzmann's constant, 1.38×10⁻²³ Joules/degree Kelvin, T is the absolute temperature, and q is the charge of an electron, 1.60×10⁻¹⁹ Coulombs. Thus, to first order, the differential base-emitter voltage between each transistor pair varies linearly with temperature with a positive, or PTAT, slope that depends on the ratio of the junction areas. The sum of these two differential base-emitter voltages appears at the emitter of transistor 126 at node 132, labeled V1 in FIG. 1. In the particular embodiment illustrated in FIG. 1, the area ratio of transistor 120 to 122 is twenty, while that of transistor 126 to 124 is thirty-one. The voltage potential at node 132, V1, is thus given by (kT/q)×ln (20×31), or 164 mV at room temperature. The coupling of the four transistors of subcircuit 110, in the arrangement specified in this embodiment and described above, creates a very low-impedance output of magnitude V1 at node 132. The low impedance means that V1 is largely immune to the effects of any downstream loads, and this characteristic allows multiple four-transistor summation stages, i.e. 112, 114, and 116, to be combined without the use of resistors. While transistors 120, 122, 124, and 126 are depicted as single transistors, it should be appreciated that each transistor may be comprised of multiple smaller transistors coupled in parallel using techniques well known in the art. The junction area ratios of the transistors may be adjusted by providing physically larger PN junction areas for some of the transistors. Alternatively, larger effective PN junction areas may be achieved by combining a larger number of smaller transistors in parallel. In one embodiment of the present invention, junction areas are set by providing switches that can selectively switch in or switch out parallel transistors, facilitating the tuning of the temperature dependence of the circuit.

The second subcircuit 112 is made up of transistors 140, 142, 144, and 146 and is identical to the first subcircuit, except that whereas the emitter of transistor 124 is grounded, the emitter of transistor 142 sits at a potential of V1. Thus, the differential base-emitter voltage that develops at the output of subcircuit 112 adds to V1, creating a potential at node 148, labeled V2, of 328 mV.

Stages three and four, subcircuits 114 and 116, are identical to the first, except that the emitter of the lower left transistor of each stage sits at the output potential of the previous stage. Thus the output node 149, labeled V4, of the fourth subcircuit 116 sits at a potential of 656 mV, or four times the differential voltage of each individual stage. Circuit simulation predicts a voltage at V4 of 653.8 mV, just 0.3% from the theoretical value, illustrating the stiffness of the voltage output of each stage, due to its low impedance, that makes such accurate voltage summation possible.

Finally, the voltage at node 149, V4, which is now an appropriately scaled PTAT voltage, is added to the voltage drop across transistor 134 that is operated as a forward-biased diode thus exhibiting a CTAT character. The resulting bandgap voltage output 138, labeled Vbg and simulated to be 1.249 V, exhibits an essentially flat temperature response. More importantly, because the circuit uses no resistors and no amplifiers, the output noise is extremely low, typically a factor of ten to twenty below the best performance achievable using the methods of the prior art, particularly in the case of the low operating currents demanded by many applications. It should be noted that some applications may require a particular temperature dependence that is not flat. In this case, tuning the junction area ratios will change the relative contributions of the PTAT and CTAT voltage contributions to the overall sum and allow for tuning of a desired temperature variation profile of the reference voltage. For example, if the sum of the PTAT voltages is set to have a larger magnitude temperature slope than that of the CTAT voltages, a net positive slope of the temperature will be obtained. Similarly, if the magnitude of the temperature slope of the PTAT voltage sum is smaller than the magnitude of the temperature slope of the CTAT voltage sum, the net temperature dependence will be negative.

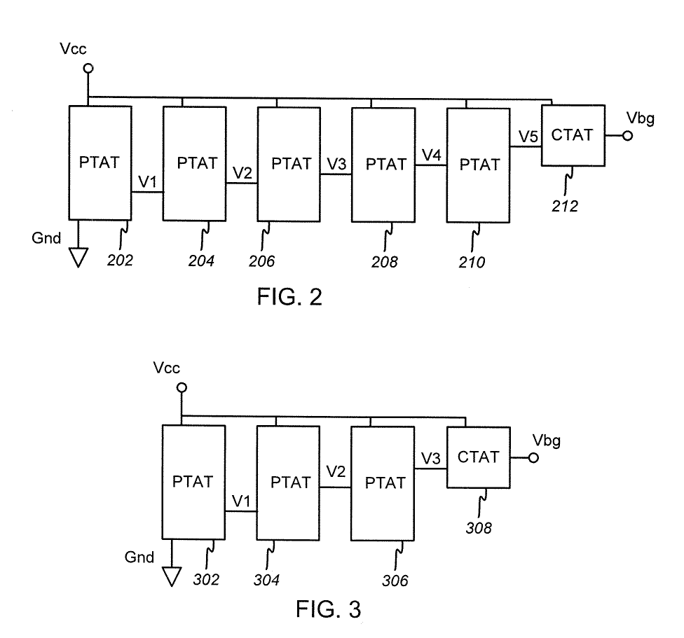

While FIG. 1 shows one possible embodiment of this invention, many variations are possible. Reducing the junction area ratio between the transistor pairs in each summation cell, e.g., the area ratio between transistors 126 and 124, will reduce the differential base-emitter voltage developed by each stage, requiring more summation stages to properly balance the PTAT and CTAT voltage components. Nearly any number of summation stages can be used to create a bandgap reference according to this invention by a judicious choice of transistor-junction-area ratios. For example, FIG. 2 illustrates an alternative embodiment of a bandgap voltage reference in accordance with the present invention. In this case five subcircuits 202, 204, 206, 208, and 210 are used to develop the PTAT voltage component. Each of the PTAT modules, e.g., 202, includes four transistors connected as shown in each of the subcircuits, e.g., 110, of FIG. 1. However, as compared to the embodiment of FIG. 1, the area ratio between the transistor pairs is reduced, resulting in an output voltage from each subcircuit, 202, 204, 206, 208, and 210, that is reduced in magnitude in proportion to the natural logarithm of the junction-area ratio between the transistor pairs. The junction-area ratio is chosen to create a PTAT voltage from each stage that is approximately one fifth of CTAT voltage developed by the CTAT circuit 212 near room temperature (for silicon transistors). The CTAT circuit 212 is identical to the output circuit of FIG. 1, comprising transistors 134 and 136, or alternatively could comprise a single PN diode junction. It should be noted that for transistors made from other semiconductor materials, such as germanium, matching the CTAT and PTAT temperature slopes will involve matching the CTAT sum voltage and the PTAT sum voltage at a temperature that differs from room temperature and depends on the semiconductor material.

FIG. 3 illustrates another embodiment of a bandgap reference in accordance with the present invention. In this case, only three PTAT subcircuits 302, 304, and 306, are employed. Each of these PTAT circuits uses transistor-pair-junction-area ratios that are correspondingly larger such that each subcircuit, e.g., 302, develops a voltage of approximately one third of that developed in the CTAT output circuit 308 near room temperature (for silicon transistors).

Transistor 134 (see FIG. 1) developing the CTAT voltage does not need to be located after the last PTAT summation stage. Rather than being added to the voltage of the final summation stage 116, as in FIG. 1, it could be located between the emitter of transistor 124 and ground, essentially shifting the entire summation string up in potential by the forward CTAT diode drop. Similarly, the CTAT diode could be placed between transistors 126 and 142, between transistors 146 and 154, or between transistors 156 and 164. In addition, the circuit topology could be altered to use PNP rather than NPN transistors, as would be readily apparent to those skilled in the art. Although FIG. 1 depicts an embodiment of the invention in silicon, this circuit is appropriate for any bipolar or mixed-signal technology.

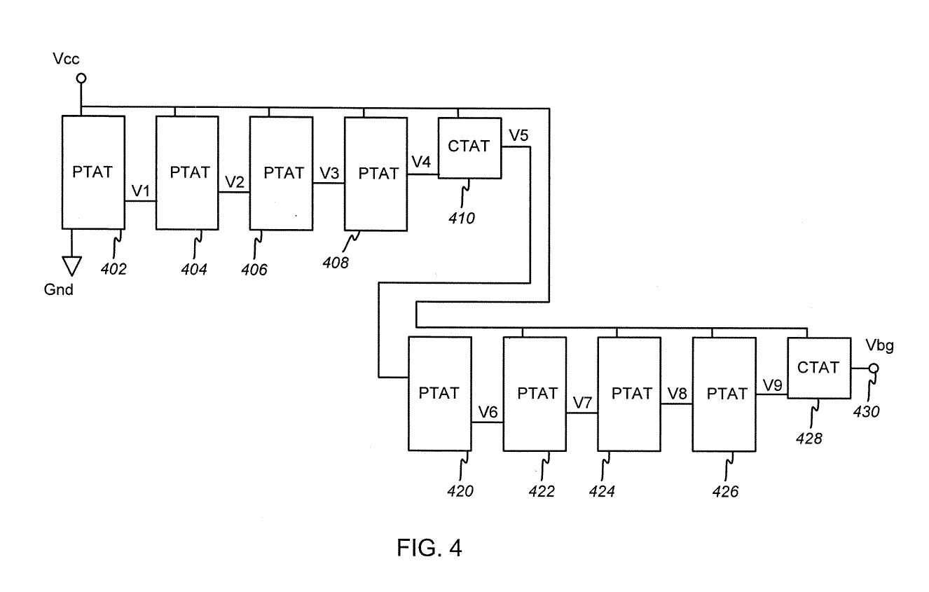

The embodiment illustrated in FIG. 1 produces an output reference voltage of approximately 1.25 V. However, with the addition of another set of summation stages and an additional CTAT diode, a reference voltage of 2.5 V is achievable by simply cascading these additional stages. FIG. 4 illustrated an example of such a cascaded circuit designed to deliver a larger output voltage. The first four PTAT stages, 402, 404, 406, and 408, combined with the first CTAT stage 410 created stable reference voltage of approximately 1.25 V that is then routed to a second set of PTAT stages, 420, 422, 424, and 426, and an additional CTAT stage 428. The output voltage Vbg 430 is approximately 2.5V in magnitude, which may be more suitable for certain applications. In comparison to prior art methods using amplification stages to scale an output reference voltage, the present invention provides a much lower noise and absolutely stable output reference. The low-impedance output of each stage makes this circuit particularly well suited to such cascading, and an output reference voltage of any multiple of 1.25 V can be produced in this manner, limited only by the voltage of the power supply Vcc.

As is evident from FIG. 1, this invention requires no resistors or control loops, other than the simple cross coupling of the transistors. Thus, the circuit is inherently stable and requires no startup circuitry. Furthermore, because there is no control loop, it will respond nearly instantaneously to changes in load currents and is thus well suited to high-speed applications. In addition, the absence of amplifiers results in an excellent power-supply-noise-rejection ratio (PSRR) over a wide range of frequencies.

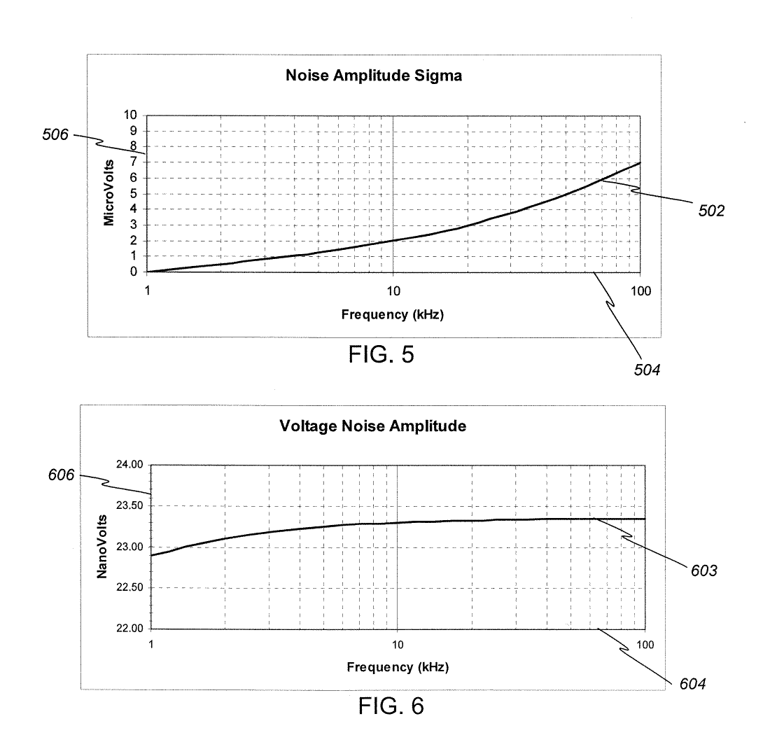

FIGS. 5 and 6 are plots of the simulated noise performance of an embodiment of this invention. In FIG. 5, the RMS voltage noise 502 is plotted along a vertical axis 506 in microVolts as a function of frequency, plotted along a logarithmic horizontal axis 504 in kilohertz. In FIG. 6, the voltage noise amplitude 603 achieved by an embodiment of the invention is plotted along a vertical axis 606 in nanoVolts as a function of frequency, plotted along a logarithmic horizontal axis 604 in kilohertz. Because this invention avoids the thermal noise inherent in resistors, or circuit elements acting as resistors, average noise levels of 5-7 uV are achievable, as is evident from the figure. By comparison, even the most carefully designed circuits using the methods of the prior art will have difficulty achieving noise levels less than 50 uV, an order of magnitude higher than the present invention, unless the prior-art circuit is operated at a very high current, which is undesirable in most applications. Thus, this invention is particularly useful for low-noise and low-current applications.

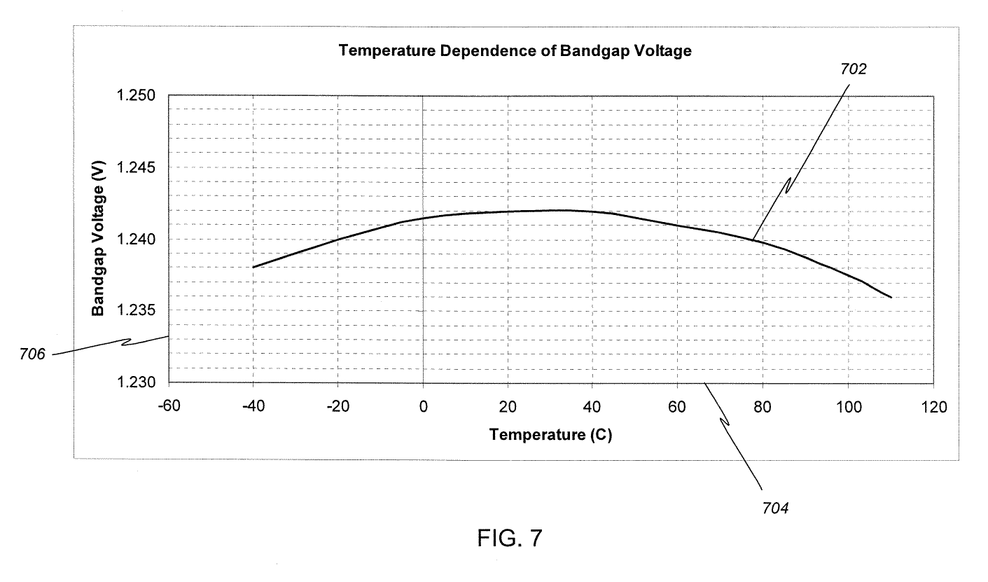

FIG. 7 is a plot of the temperature dependence of the output bandgap reference voltage. For one embodiment in accordance with the present invention, the output reference voltage 702, is plotted along a vertical axis 706 in Volts as a function of temperature, plotted along a horizontal axis 704 in degrees Celsius. By matching the CTAT and PTAT components of the output reference voltage, the first-order temperature dependencies cancel, leaving only the residual nonlinear components. As indicated in FIG. 7, over a temperature range from −40 degrees Celsius to 110 degrees Celsius, the variation in output voltage is only about 7 mV, or 0.5%. This performance is comparable to that achieved using the methods of the prior art, although the present invention achieves better initial accuracy and lower production costs by avoiding the time and expense of tuning that is associated with designs using resistors. To correct for the residual second-order temperature dependence of this circuit, standard compensation methods, well known to those skilled in the art, may be applied to this circuit, and the resulting further linearized circuit would fall within the scope and spirit of the present invention.

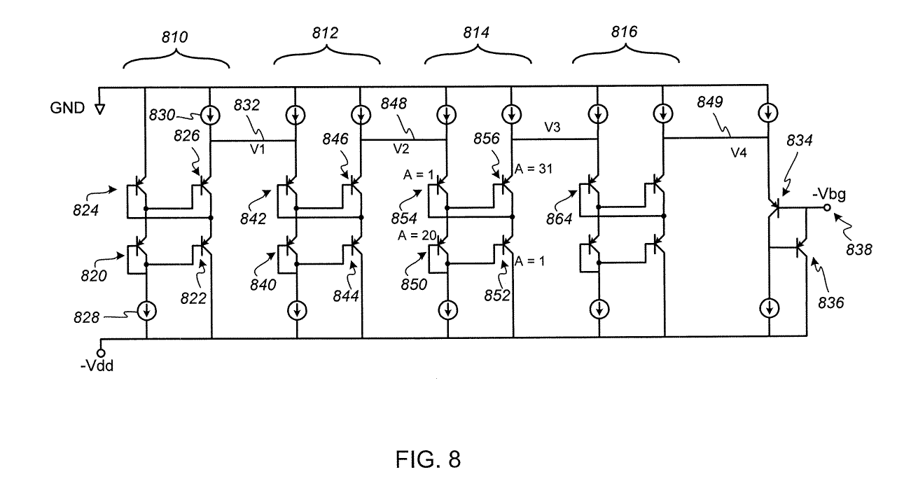

FIG. 8 is a simplified schematic diagram of an alternative embodiment of a bandgap reference in accordance with the present invention that is implemented with PNP transistors to produce a negative reference voltage. The circuit is very similar to that shown in FIG. 1. A CTAT stage comprising transistors 834 and 836 produces a voltage output that decreases with increasing temperature. The collector of transistor 834 connects to the base of transistor 836, and the emitter of transistor 836 connects to the base of transistor 834. The bandgap voltage output is taken from the emitter of transistor 836.

The circuit also comprises four PTAT stages, 810, 812, 814, and 816, each comprising four transistors. In each stage, the transistors are cross coupled as shown. For example, in the first stage 810, the collector of transistor 824 connects to the emitter of transistor 820 and to the base of transistor 826. The collector of transistor 820 connects to its own base and to the base of transistor 822. The collector of transistor 826 connects to the base of transistor 824 and the emitter of transistor 822. The low-impedance output is taken from the emitter of transistor 826. Stages 812, 814, and 816 are coupled in the same fashion. Of course, many other variations are possible and would fall within the scope and spirit of the present invention. For example, the CTAT stage, comprising transistors 834 and 836 does not need to be located at the right-hand end of the circuit, after all the PTAT components have been summed. It could be located directly at the negative power supply, or between any two of the PTAT stages. Similarly, a different number of PTAT and CTAT stages may be used, with appropriate adjustments to the transistor junction-area ratios, as described above. Other advantages and embodiments of the invention may be evident to those skilled in the art and would also fall within the scope and spirit of the present invention. The invention is further defined by the following claims.

What is claimed is:

1. A bandgap voltage reference circuit comprising:
M complementary subcircuits, each adapted to produce a complementary-to-absolute-temperature (CTAT) voltage output wherein:
M is an integer greater than zero; and
the CTAT voltage output of each of the M complementary subcircuits is adapted to decrease substantially linearly with increasing temperature; and
N proportional subcircuits, each adapted to produce a low-impedance proportional-to-absolute-temperature (PTAT) voltage output wherein:
N is an integer greater than zero; and
the PTAT voltage output of each of the N proportional subcircuits is adapted to increase substantially linearly with increasing temperature;
wherein the N proportional subcircuits and the M complementary subcircuits combine in series to produce a bandgap reference output voltage.

2. The bandgap voltage reference circuit of claim 1, wherein the N proportional subcircuits are adapted such that an absolute value of a sum of the N PTAT voltage outputs varies with temperature with a slope that is substantially equal to an absolute value of a slope of a variation with temperature of a sum of the M CTAT voltage outputs such that the bandgap reference output voltage is substantially constant with temperature.

3. The bandgap voltage reference circuit of claim 1, wherein each of the M complementary subcircuits comprises a PN diode junction.

4. The bandgap voltage reference circuit of claim 1, wherein each of the M complementary subcircuits comprises:
a first NPN transistor including an emitter, a collector, and a base; and
a second NPN transistor including an emitter, a collector, and a base, wherein:
the collector of the first NPN transistor connects to the base of the second NPN transistor; and
the emitter of the second NPN transistor connects to the base of the first NPN transistor;
wherein the CTAT output is taken from the emitter of the second NPN transistor.

5. The bandgap voltage reference circuit of claim 1, wherein each of the N proportional subcircuits comprises:
a first NPN transistor comprising a collector, an emitter, and a base;
a second NPN transistor comprising a collector, an emitter, and a base;
a third NPN transistor comprising a collector, an emitter, and a base; and
a fourth NPN transistor comprising a collector, an emitter, and a base;
wherein the first, second, third, and fourth NPN transistors are cross coupled as follows:
the collector of the first NPN transistor connects to the base of the first NPN transistor and to the base of the second NPN transistor;
the emitter of the first NPN transistor connects to the collector of the third NPN transistor and to the base of the NPN fourth transistor; and
the emitter of the second NPN transistor connects to the base of the third NPN transistor and to the collector of the fourth NPN transistor;
wherein the low-impedance PTAT output is taken from the emitter of the fourth NPN transistor; and
wherein a junction area of at least one of the first, second, third and fourth NPN transistors is larger than a junction area of at least one other one of the first, second, third, and fourth NPN transistors.

6. The bandgap voltage reference circuit of claim 5, wherein at least one of the first, second, third, and fourth NPN transistors comprises a plurality of smaller transistors combined in parallel.

7. The bandgap voltage reference circuit of claim 6, wherein the least one of the first, second, third, and fourth NPN transistors further comprises a switch adapted to selectively switch in and out at least one of the plurality of smaller transistors combined in parallel.

8. The bandgap voltage reference circuit of claim 5, wherein the PTAT output voltage of each of the N proportional subcircuits is adapted to be substantially equal to one Nth of a sum of the M CTAT voltage outputs by adjusting a first junction-area ratio of the first NPN transistor to the second NPN transistor and a second junction-area ratio of the fourth NPN transistor to the third NPN transistor, wherein the PTAT voltage output of each of the N proportional subcircuits is given by a natural logarithm of a product of the first junction-area ratio and the second junction-area ratio, scaled by a product of Boltzmann's constant and an absolute temperature divided by a charge of an electron.

9. The voltage reference circuit of claim 8, wherein:
N is equal to four;
M is equal to one; and
the PTAT voltage output of each of the four proportional subcircuits is adjusted to be substantially equal to one fourth of the CTAT voltage output of the one complementary subcircuit by selecting an appropriate first junction-area ratio and an appropriate second junction-area ratio.

10. The bandgap voltage reference circuit of claim 8, wherein:
N is equal to four;
M is equal to one;
the first junction-area ratio between the first and second NPN transistors is approximately equal to twenty; and
the second junction-area ratio between the fourth and third NPN transistors is approximately equal to thirty-one.

11. The bandgap voltage reference circuit of claim 1, wherein each of the M complementary subcircuits comprises:
a first PNP transistor including an emitter, a collector, and a base; and
a second PNP transistor including an emitter, a collector, and a base, wherein:
the collector of the first PNP transistor connects to the base of the second PNP transistor; and
the emitter of the second PNP transistor connects to the base of the first PNP transistor;
wherein the CTAT output is taken from the collector of the second PNP transistor.

12. The bandgap voltage reference circuit of claim 1, wherein each of the N proportional subcircuits comprises:
a first PNP transistor comprising a collector, an emitter, and a base;
a second PNP transistor comprising a collector, an emitter, and a base;
a third PNP transistor comprising a collector, an emitter, and a base; and
a fourth PNP transistor comprising a collector, an emitter, and a base;
wherein the first, second, third, and fourth PNP transistors are cross coupled as follows:
the collector of the first PNP transistor connects to the base of the second PNP transistor, and to the emitter of the third PNP transistor;
the collector of the third PNP transistor connects to the base of the third PNP transistor and to the base of the fourth PNP transistor; and
the collector of the second PNP transistor connects to the base of the first PNP transistor and to the emitter of the fourth PNP transistor;
wherein the low-impedance PTAT output is taken from the emitter of the second PNP transistor; and
wherein a junction area of at least one of the first, second, third and fourth PNP transistors is larger than a junction area of at least one other one of the first, second, third, and fourth PNP transistors.

13. The bandgap voltage reference circuit of claim 12, wherein at least one of the first, second, third, and fourth PNP transistors comprises a plurality of smaller transistors combined in parallel.

14. The bandgap voltage reference circuit of claim 13, wherein the least one of the first, second, third, and fourth PNP transistors further comprises a switch adapted to selectively switch in and out at least one of the plurality of smaller transistors combined in parallel.

15. The bandgap voltage reference circuit of claim 12, wherein the PTAT output voltage of each of the N proportional subcircuits is adapted to be substantially equal to one Nth of a sum of the M CTAT voltage outputs by adjusting a first junction-area ratio of the second PNP transistor to the first PNP transistor and a second junction-area ratio of the third PNP transistor to the fourth PNP transistor, wherein the PTAT voltage output of each of the N proportional subcircuits is given by a natural logarithm of a product of the first junction-area ratio and the second junction-area ratio, scaled by a product of Boltzmann's constant and an absolute temperature divided by a charge of an electron.

16. The voltage reference circuit of claim 15, wherein:
N is equal to four;
M is equal to one; and
the PTAT voltage output of each of the four proportional subcircuits is adjusted to be substantially equal to one fourth of the CTAT voltage output of the one complementary subcircuit by selecting an appropriate first junction-area ratio and an appropriate second junction-area ratio.

17. The bandgap voltage reference circuit of claim 15, wherein:
N is equal to four;
M is equal to one;
the first junction-area ratio between the second and first PNP transistors is approximately equal to thirty-one; and
the second junction-area ratio between the third and fourth PNP transistors is approximately equal to twenty.

18. A method of creating a bandgap voltage reference comprises the steps of:
providing M complementary subcircuits, each adapted to produce a complementary-to-absolute-temperature (CTAT) voltage output, wherein M is an integer greater than zero;
adapting the M complementary subcircuits such that the CTAT voltage output of each of the M complementary subcircuits decreases in a substantially linear fashion with increasing temperature;
providing N proportional subcircuits, each adapted to produce a low-impedance proportional-to-absolute-temperature (PTAT) voltage output, wherein N is an integer greater than zero;
adapting the N proportional subcircuits such that the PTAT voltage output of each of the N proportional subcircuits increases in a substantially linear fashion with increasing temperature;
combining the N proportional subcircuits and the M complementary subcircuits in series to produce a bandgap reference output voltage.

19. The method of claim 18, wherein the step of providing N proportional subcircuits further comprises adapting the N proportional subcircuits such that an absolute value of a sum of the N PTAT voltage outputs varies with temperature with a slope that is substantially equal to an absolute value of a slope of a variation with temperature of a sum of the M CTAT voltage outputs such that the bandgap reference output voltage is substantially constant with temperature.

20. The method of claim 18, wherein the step of providing M complementary subcircuits further comprises providing M PN diode junctions.

21. The method of claim 18, wherein the step of providing M complementary subcircuits further comprises:
connecting a collector of a first NPN transistor to a base of a second NPN transistor;
connecting an emitter of the second NPN transistor to a base of the first NPN transistor;
taking the CTAT voltage output from the emitter of the second NPN transistor; and
repeating the above steps for each of the M complementary subcircuits.

22. The method of claim 18, wherein the step of providing N proportional subcircuits further comprises:
connecting a collector of a first NPN transistor to a base of the first NPN transistor and to the base of a second NPN transistor;
connecting an emitter of the first NPN transistor to a collector of a third NPN transistor and to a base of a fourth NPN transistor;
connecting an emitter of the second NPN transistor to a base of the third NPN transistor and to a collector of the fourth NPN transistor;
taking the low-impedance PTAT output from an emitter of the fourth NPN transistor;
adjusting a junction area of at least one of the first, second, third, and fourth NPN transistors to be larger than a junction area of at least one other of the first, second, third, and fourth NPN transistors; and
repeating the above steps for each of the N proportional subcircuits.

23. The method of claim 22, wherein the step of adjusting a junction area of at least one of the first, second, third, and fourth NPN transistors further comprises selectively switching in and out at least one of a plurality of smaller transistors combined in parallel to comprise the at least one of the first, second, third, and fourth NPN transistors.

24. The method of claim 22, wherein the step of adjusting a junction area of at least one of the first, second, third, and fourth NPN transistors further comprises:
adjusting a first junction-area ratio of the first NPN transistor to the second NPN transistor; and
adjusting a second junction-area ratio of the fourth NPN transistor to the third NPN transistor, such that the PTAT output voltage of each of the N proportional subcircuits is adapted to be substantially equal to one Nth of a sum of the M CTAT voltage outputs;
wherein the PTAT voltage output of each of the N proportional subcircuits is given by a natural logarithm of a product of the first junction-area ratio and the second junction-area ratio, scaled by a product of Boltzmann's constant and an absolute temperature divided by a charge of an electron.

25. The method of claim 24, further comprising the steps of:
selecting N to be equal to four;
selecting M to be equal to one;
adjusting the first junction-area ratio and the second junction-area ratio to set the PTAT voltage output of each of the four proportional subcircuits to be substantially equal to one fourth of the CTAT voltage output of the one complementary subcircuit.

26. The method of claim 24, further comprising the steps of:
selecting N to be equal to four;
selecting M to be equal to one;
adjusting the first junction-area ratio between the first and second NPN transistors to be approximately equal to twenty; and
adjusting the second junction-area ratio between the fourth and third NPN transistors to be approximately equal to thirty-one.

27. The method of claim 18, wherein the step of providing M complementary subcircuits further comprises:
connecting a collector of a first PNP transistor to a base of a second PNP transistor;
connecting an emitter of the second PNP transistor to a base of the first PNP transistor;
taking the CTAT voltage output from the emitter of the second PNP transistor; and
repeating the above steps for each of the M complementary subcircuits.

28. The method of claim 18, wherein the step of providing N proportional subcircuits further comprises:
connecting a collector of a first PNP transistor to a base of a second PNP transistor, and to an emitter of a third PNP transistor;
connecting a collector of the third PNP transistor to a base of the third PNP transistor and to a base of a fourth PNP transistor;
connecting a collector of the second PNP transistor to a base of the first PNP transistor and to an emitter of the fourth PNP transistor;
taking the low-impedance PTAT output from an emitter of the second PNP transistor;
adjusting a junction area of at least one of the first, second, third, and fourth PNP transistors to be larger than a junction area of at least one other of the first, second, third, and fourth PNP transistors; and
repeating the above steps for each of the N proportional subcircuits.

29. The method of claim 28, wherein the step of adjusting a junction area of at least one of the first, second, third, and fourth PNP transistors further comprises selectively switching in and out at least one of a plurality of smaller transistors combined in parallel to comprise the at least one of the first, second, third, and fourth PNP transistors.

30. The method of claim 28, wherein the step of adjusting a junction area of at least one of the first, second, third, and fourth PNP transistors further comprises:
adjusting a first junction-area ratio of the second PNP transistor to the first PNP transistor; and
adjusting a second junction-area ratio of the third PNP transistor to the fourth PNP transistor, such that the PTAT output voltage of each of the N proportional subcircuits is adapted to be substantially equal to one Nth of a sum of the M CTAT voltage outputs;
wherein the PTAT voltage output of each of the N proportional subcircuits is given by a natural logarithm of a product of the first junction-area ratio and the second junction-area ratio, scaled by a product of Boltzmann's constant and an absolute temperature divided by a charge of an electron.

31. The method of claim 30, further comprising the steps of:
selecting N to be equal to four;
selecting M to be equal to one;
adjusting the first junction-area ratio and the second junction-area ratio to set the PTAT voltage output of each of the four proportional subcircuits to be substantially equal to one fourth of the CTAT voltage output of the one complementary subcircuit.

32. The method of claim 30, further comprising the steps of:
selecting N to be equal to four;
selecting M to be equal to one;
adjusting the first junction-area ratio between the second and first PNP transistors to be approximately equal to thirty-one; and
adjusting the second junction-area ratio between the third and fourth PNP transistors to be approximately equal to twenty.
